(19) United States
(12) Patent Application Publication
(10) Pub. No.: US 2022/0112697 A1
(43) Pub. Date: Apr. 14, 2022

(54) BACKFLOW PREVENTION APPARATUS AND METHOD

(71) Applicant: Elvin Sanichar, Jersey City, NJ (US)

(72) Inventor: Elvin Sanichar, Jersey City, NJ (US)

(21) Appl. No.: 17/445,995

(22) Filed: Aug. 26, 2021

Related U.S. Application Data
(60) Provisional application No. 63/198,376, filed on Oct. 14, 2020.

(51) Int. Cl. E03B 7/07; F16K 15/14

(52) U.S. Cl. CPC E03B 7/077; F16K 15/1471

(57) ABSTRACT

A backflow prevention system and apparatus is disclosed. The system includes a pipe designed to couple to a washer. The backflow prevention apparatus includes a housing and two one-way valves. The housing secured to the pipe. A first one-way valve is coupled to the housing, with the first one-way valve defining a first cross-slit. A second one-way valve is coupled to the housing and spaced from the first one-way valve, with the second one-way valve defining a second cross-slit. The first one-way valve and the second one-way valve are designed to allow fluid flow, through the housing, in a first direction and prevent flow of suds, foam, gas, or combinations thereof in a second direction opposite the first direction.

### CROSS-REFERENCE TO RELATED APPLICATION

This application claims the benefit of priority of U.S. provisional application No. 63/198,376, filed Oct. 14, 2020, the contents of which are herein incorporated by reference.

### BACKGROUND OF THE INVENTION

The present invention relates to plumbing, and more particularly, to a backflow prevention apparatus and method.

In commercial buildings, multi-unit dwellings, multi-family dwellings, and even residential buildings, such as single-family dwellings, in which two or more machines, such as clothes washing machines and dishwashers, are connected in series on a common drain and sewer line, soapsuds and foam, and fumes may back up into the washing machines. This back up occurs because of the series connection on the common drain/sewer line. For example, backflow of soapsuds or the like may occur from one washer (e.g., clothes washing machine or dishwasher) into another washer that is connected on the same drain or sewer line. This is a particularly common issue especially when a washer on the shared line is not in use. Soapsuds, foam, or gases from one washer may contaminate another washer through thru backflow.

Further, single family homes in close proximity on a common sewer line may experience backing up of soapsuds, foam and fumes from the common sewer line. In addition, in all plumbing applications, there is a need for reduction and prevention of sewer fumes and sewer backup in open drain applications such as basements, and in prevention of sewer backup of rainwater runoff or the like.

As can be seen, is a need for an apparatus which is capable of reducing or eliminating backflow, and preventing soapsuds, foam and fumes from backing up into commercial washing machines and washing machines in other types of buildings (e.g., residential buildings).

### SUMMARY OF THE INVENTION

In one aspect of the present invention, a backflow prevention apparatus comprises: a housing configured to secure to a pipe; a first one-way valve coupled to the housing, with the first one-way valve comprising a first cross-slit; and a second one-way valve coupled to the housing and spaced from the first one-way valve, with the second one-way valve comprising a second cross-slit, the first one-way valve and the second one-way valve being configured to allow fluid flow in a first direction, though the housing, and prevent flow of suds, foam, gas, or combinations thereof in a second direction opposite the first direction.

In another aspect of the present invention, a backflow prevention system comprises: a pipe configured to couple to a washer; a backflow prevention apparatus comprising: a housing secured to the pipe; a first one-way valve coupled to the housing, with the first one-way valve comprising a first cross-slit; and a second one-way valve coupled to the housing and spaced from the first one-way valve, with the second one-way valve comprising a second cross-slit, the first one-way valve and the second one-way valve being configured to allow fluid flow, through the housing, in a first direction and prevent flow of suds, foam, gas, or combinations thereof in a second direction opposite the first direction.

In yet another aspect of the present invention, a method of preventing fluid backflow comprises: providing a washer; coupling a pipe to the washer;

providing a backflow prevention apparatus comprising: a housing secured to the pipe; a first one-way valve coupled to the housing, with the first one-way valve comprising a first cross-slit; and a second one-way valve coupled to the housing and spaced from the first one-way valve, with the second one-way valve comprising a second cross-slit; and discharging a fluid from the washer to flow in a first direction, the first one-way valve and the second one-way valve allowing fluid flow, through the housing, in the first direction and preventing flow of suds, foam, gas, or combinations thereof in a second direction opposite the first direction.

These and other features, aspects and advantages of the present invention will become better understood with reference to the following drawings, description and claims.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is a perspective view of a backflow prevention apparatus in accordance with an exemplary embodiment of the present invention;

FIG. 2 is a perspective view of the backflow prevention apparatus, similar to FIG. 1, with a portion of a cylindrical housing cut away to expose one-way valves of the exemplary embodiment;

FIG. 3 is a top view of the backflow prevention apparatus;

FIG. 4 is a bottom view of the backflow prevention apparatus;

FIG. 5 is a view of the backflow prevention apparatus in accordance with the exemplary embodiment of the present invention, shown in use in use with a pipe (shown in phantom lines);

FIG. 6 is a bottom perspective view of the backflow prevention apparatus, with a portion of the cylindrical housing cut away to expose the one-way valves of the exemplary embodiment, with one of the one-way valves being shown in an open position; and

FIG. 7 is a front view of two backflow prevention apparatuses in accordance with the exemplary embodiment of the present invention, shown in use connected to two respective washing machines.

### DETAILED DESCRIPTION OF THE INVENTION

The subject disclosure is described with reference to the drawings, wherein like reference numerals are used to refer to like elements throughout. In the following description, for purposes of explanation, numerous specific details are set forth in order to provide a thorough understanding of the present disclosure such that one skilled in the art will be enabled to make and use the present invention. It may be evident, however, that the present disclosure may be practiced without some of these specific details.

Broadly, an embodiment of the present invention provides a backflow prevention apparatus. The backflow prevention apparatus of the present invention may be used to prevent, reduce, and/or eliminate backflow of soapsuds, foam, and fumes. More specifically, the apparatus of the present invention may be used to prevent backflow into a dishwasher or a clothes washing machine from a plumbing or sewer line. The apparatus of the present invention may be beneficially used in commercial buildings, multi-unit dwellings, multi-family dwellings, and even single-family dwellings, wherein two or more machines such as clothes washing machines and dishwashers are connected in a series on a common drain and sewer line. Further, the apparatus of the present invention may be beneficially used to prevent backflow into single family homes from other homes in close proximity on a common sewer line. Still further, the apparatus of the present invention may be used in any plumbing applications, to provide reduction and prevention of sewer fumes and sewer backup in open drain applications such as basements, and in prevention of sewer backup of rainwater runoff or the like.

As stated above, the apparatus of the present invention solves the problems of backflow and prevents soapsuds, foam, and gases from backing up into appliances that are connected in series on a common drain or sewer line. A nonlimiting example of the type of backflow which may be prevented by the apparatus of the present invention is backflow of soapsuds from one washer into another washer that is connected on the same drain or sewer line. This is a common issue especially when a washer on the same line is not in use. Soapsuds or the like from one washer can contaminate another through backflow. The apparatus of the present invention may be installed by connecting the apparatus to the drain line of each machine to prevent the contamination that would otherwise be cause by the backflow.

In addition, embodiments of the present invention may resolve and prevent backflow in any plumbing application, such as, and for example without limitation, sewer fumes and sewer backup in open drain applications such as basements, and in sewer backup of rainwater runoff, or the like. No other existing apparatus provides backflow elimination, prevention, or reduction, which effectively solves these aforementioned issues.

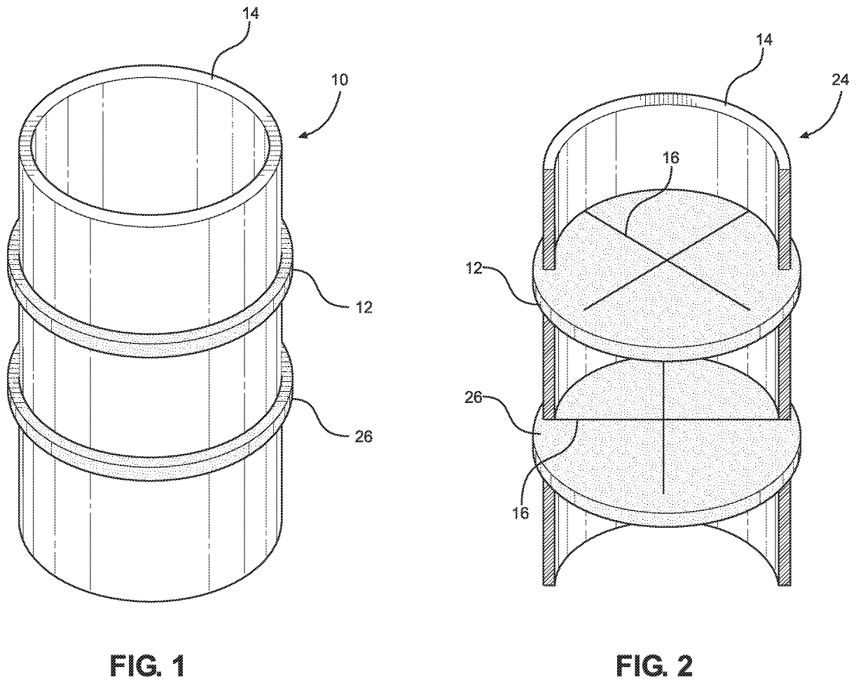

Referring to FIGS. 1-7, in an exemplary embodiment, the components are interrelated as shown in the drawings. FIG. 1 is a perspective view of a backflow prevention apparatus 10 in accordance with an exemplary embodiment of the present invention. FIG. 2 is a partial cross-section of the apparatus 10 as in FIG. 1, providing a cutaway view to enhance detail.

Making reference to FIG. 1, the apparatus 10 may have a first end, a second end and an exterior portion. The apparatus 10 may comprise a cylindrical housing 14 with a sidewall, with the housing sidewall defining an interior portion. In certain embodiments, the housing 14 may be formed from a rigid material. The housing 14 may be made of any suitable material, such as, for example without limitation, plastic materials of sufficient rigidity, including PVC. The housing 14 may be of any suitable dimensions depending on where the apparatus 10 is installed, as it may be used for any plumbing application. For example, and without limitation, the housing 14 may have a diameter of between about 1 to 6 inches, though diameters of greater than 0 inch and less than 1 inch may be contemplated depending on the application of the apparatus. In some embodiments, the housing 14 has a diameter of about 4 to 6 inches. In some embodiments, the housing 14 may have a diameter of between about 4 to 5 inches. In some embodiments, the housing 14 may have a longitudinal length of about 5 to 6 inches.

As shown in FIG. 2, the apparatus 10 may further comprise at least one one-way valve (see, for example, a first one-way valve 12) comprising a cross-slit 16 (as shown, substantially X-shaped or “+” shaped). The at least one one-way valve is carried by the housing 12 and secured thereto. As seen in FIGS. 1-2, the at least one one-way valve may comprise a first one-way valve 12 and a second one-way valve 26, with the second one-way valve being disposed in the housing 14 so that slits 16 thereof are positioned at an angle with respect to the first one-way valve 12. The one-way valves 12, 26 each may be formed from a pliant, flexible material/membrane. It will be appreciated by those with skill in the art that the one-way valve 12, 26 may be configured to be flexible in a single direction to provide for only unidirectional flow (i.e., no backflow is permitted). The first and second one-way valves 12, 26, together, form a valve assembly (also considered a “set” or “pair”) which may provide an unprecedented highly effective means of reducing suds and fumes in plumbing applications. The slits of the first valve 12 (also referred to as a membrane) may be positioned at between about a 1 to 89 degree rotational angle relative to the slits of the second membrane. Preferably, in one embodiment, the slits of the first membrane may be positioned at a rotational angle of about 45 degrees relative to the slits of the second valve 26. The valve assembly 12, 26 and portions thereof may be made of any suitable material, such as, for example without limitation, rubber, silicone rubber or plastic. The flexible membrane components with slits 16 at different angles may operate to provide a more effective means of reducing or eliminating soapsuds, foam and fumes in plumbing applications. The one-way valves 12, 26 may be secured to the housing 14 by any suitable means, such as for example, any suitable adhesive composition, or bonding method.

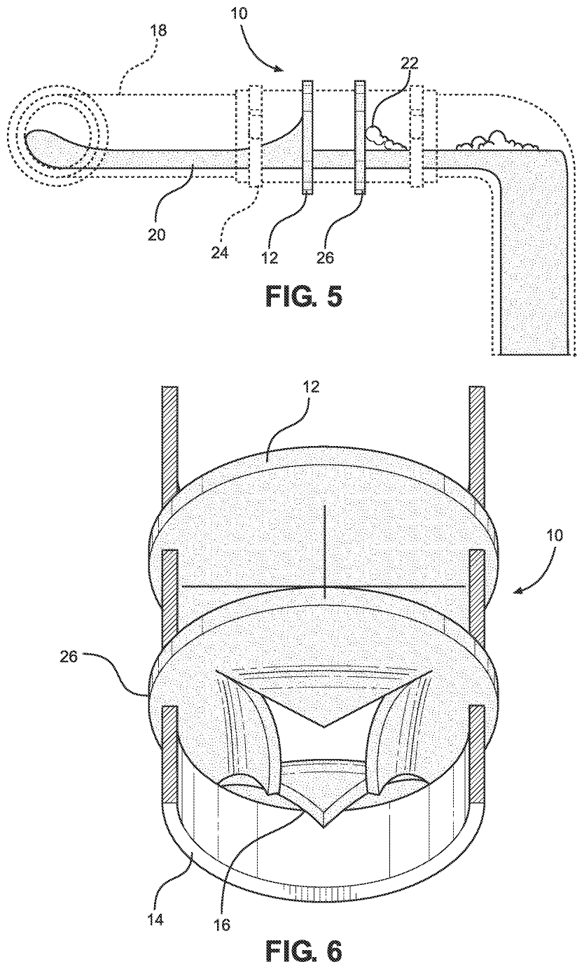

As shown in FIG. 5, the apparatus 10 may further comprise a pair of clamps 24 (or other securement means). The securement means may be any suitable clamp 24 or securement means for securing the apparatus to a plumbing system (see FIG. 5) or the like. The pair of clamps 24 may comprise a first clamp 24 located at the first end of the apparatus and a second clamp (not labelled, but see the right side of the apparatus 10 shown in FIG. 5) located at the second end of the apparatus.

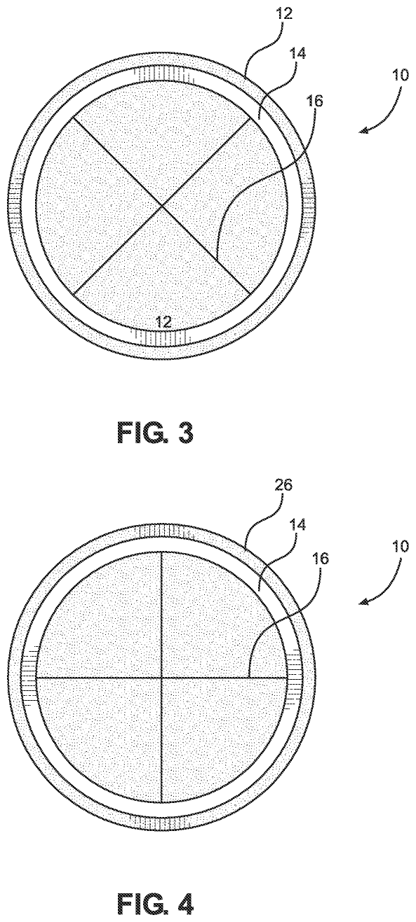

FIG. 3 is a top view and FIG. 4 is a bottom view which show the relative position between the one-way valves 12, 26. As can be seen with particular reference to FIG. 2 and FIG. 6 which provide cutaway views of the housing 14, the perimeter of each one-way valve 12, 26 may also extend beyond the perimeter of the housing 14, and the one-way valves 12, 26 may thereby provide additional securement and insulation of the apparatus 10 within the system or pipe in which it is installed. As shown, the housing 14 may be embodied as non-continuous such that the valves 12, 26 may extend beyond the housing 14 in the above-described manner.

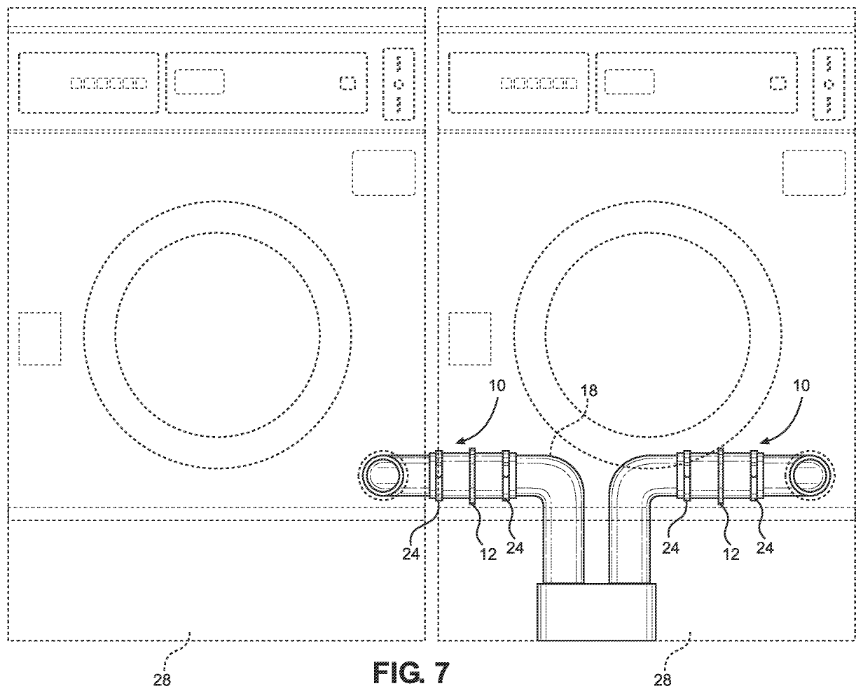

FIGS. 5 and 7 are views of the backflow prevention apparatus 10 in use in accordance with an exemplary embodiment of the present invention. As seen with respect to FIGS. 5 and 7, in use, the apparatus 10 may allow a pipe 18 (shown in phantom in FIG. 5), such as for example without limitation, a pipe used for carrying water from a washing machine 28 (the apparatus 10 is shown at FIG. 7 connected to a washing machine 28, shown in phantom), to carry soapy water 20 from the machine 28, while preventing backflow of soapsuds 22 (and/or foam and/or gases). The apparatus 10 is attached to the pipe 18 by clamps 24. As demonstrated in FIG. 6, a partial cutaway cross-section view, in use, the one-way valve material may provide flexibility in one direction sufficient to enable the opening of the valve assembly 12, 26 to allow the water 20 to be carried from the machine while preventing backflow (e.g., flow from right to left in FIG. 5).

In use, the apparatus 10 of the present invention may stop backflow of soapsuds 22, foam and fumes from one appliance to another appliance located on the same drain line or a common sewer line. For example, as shown in FIG. 7, the apparatus may prevent backflow of soapsuds from one washer 28 (e.g., left washer 28 in FIG. 7) into another washer (e.g., right washer 28 in FIG. 7) that is connected on the same drain or sewer line (both connected to the drain/sewer line by pipes 18, as shown in FIG. 7). This is a common issue especially when a washer on the same line is not in use. Soapsuds 22 from one washer 28 could, prior to the present invention, contaminate another thru backflow.

The apparatus 10 of the present invention may be fabricated of any suitable materials, by any suitable fabrication method. In an exemplary embodiment, a PVC pipe would be used along with a one-way valve assembly 12, 26 of rubber or silicone components held therein to provide the function of preventing backflow of soapsuds 22, foam or gases. In some embodiments, each rubber component may comprise a flexible membrane having slits or cuts similar to an “X” to allow the washer 28 to drain while preventing flow in the opposite direction. Specifically, the valve components may be fabricated form a rubber or silicone sheet. The various components of the apparatus 10 may be made in any suitable dimensions. The apparatus 10 may be provided in multiple or varying sizes to accommodate different size drains.

The apparatus of the present invention may easily be installed in a process comprising one or more of the following steps and combinations thereof. The existing drain line (e.g., pipe 18) may be located. A portion of the existing drain line may be cut at the specified length to accommodate installation of the apparatus 10 of the present invention. The cut portion of the existing drain line may be removed. The apparatus 10 of the present invention may then be installed in place of the removed portion of the existing drain line with any suitable securement means. In one embodiment, the apparatus may be secured with two clamps 24 provided at opposite ends of the apparatus 10. As seen at FIGS. 5 and 7, clamps 24 hold the apparatus 10 securely in place.

In summary, a backflow prevention apparatus includes and may be used in the following manner. The backflow prevention apparatus comprises a housing, a one-way valve and securement means. The backflow prevention apparatus may eliminate, prevent and resolve the problem of backflow, such as, for example without limitation, from one appliance to others on a common drain or sewer line, or between homes on a common sewer line, or in all plumbing applications, backflow of sewer fumes and sewer backup in open drain applications such as basements, and in prevention of sewer backup of rainwater runoff or the like.

For clarity, only those aspects of the system germane to the invention are described, and product details well known in the art are omitted. In addition, many embodiments of the present invention have application to a wide range of industries. To the extent the present application discloses a system, the method implemented by that system is within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the present invention.

While apparatuses and methods are described in terms of “comprising,” “containing,” or “including” various components or steps, the apparatuses and methods can also “consist essentially of” or “consist of” the various components and steps. All numbers and ranges disclosed above may vary by some amount.

Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a- b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

Moreover, the use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A backflow prevention apparatus comprising:
a housing configured to secure to a pipe;
a first one-way valve coupled to the housing, with the first one-way valve comprising a first cross-slit; and
a second one-way valve coupled to the housing and spaced from the first one-way valve, with the second one-way valve comprising a second cross-slit,
the first one-way valve and the second one-way valve being configured to allow fluid flow in a first direction, though the housing, and prevent flow of suds, foam, gas, or combinations thereof in a second direction opposite the first direction.

2. The backflow prevention apparatus of claim 1, wherein the first cross-slit and the second cross slit are oriented at an angle relative to one another.

3. The backflow prevention apparatus of claim 2, wherein the angle is approximately 45 degrees.

4. The backflow prevention apparatus of claim 1, wherein the first one-way valve and the second one-way valve each comprise a flexible material that permits bending in the first direction and substantially prevents bending in the second direction.

5. The backflow prevention apparatus of claim 1, wherein the first one-way valve and the second one-way valve each have an outer portion that projects from the housing.

6. The backflow prevention apparatus of claim 1, wherein the first cross-slit and the second cross-slit both extend across an entire inner diameter of the housing.

7. A backflow prevention system comprising:
a pipe configured to couple to a washer;
a backflow prevention apparatus comprising:
a housing secured to the pipe;
a first one-way valve coupled to the housing, with the first one-way valve comprising a first cross-slit; and
a second one-way valve coupled to the housing and spaced from the first one-way valve, with the second one-way valve comprising a second cross-slit,
the first one-way valve and the second one-way valve being configured to allow fluid flow, through the housing, in a first direction and prevent flow of suds, foam, gas, or combinations thereof in a second direction opposite the first direction.

8. The backflow prevention system of claim 7, wherein the first cross-slit and the second cross slit are oriented at an angle relative to one another.

9. The backflow prevention system of claim 7, wherein the first one-way valve and the second one-way valve each comprise a flexible material that permits bending in the first direction and substantially prevents bending in the second direction.

10. The backflow prevention system of claim 7, wherein the pipe comprises a first pipe section and a second pipe section, and the backflow prevention apparatus is secured to the pipe between the first pipe section and the second pipe section.
